(19) United States
(12) Patent Application Publication
(10) Pub. No.: US 2026/0286060 A1
(43) Pub. Date: Sep. 24, 2026

(54) COVALENT ADAPTABLE NETWORKS WITH ASSOCIATIVE SILOXANE EXCHANGE ENABLED BY AMIDE-BASED INTERNAL CATALYSIS

(71) Applicant: Northwestern University, Evanston, IL (US)

(72) Inventors: John Mark Torkelson, Skokie, IL (US); Nathan Suryajaya Purwanto, Morton Grove, IL (US); Tong Wang, Evanston, IL (US); Tapas Debsharma, Evanston, IL (US)

(21) Appl. No.: 19/569,216

(22) Filed: Mar. 17, 2026

Related U.S. Application Data
(60) Provisional application No. 63/774,273, filed on Mar. 19, 2025.

(51) Int. Cl. C08G 77/455; C08J 3/24

(52) U.S. Cl. CPC C08G 77/455; C08J 3/24

(57) ABSTRACT

Provided are siloxane-containing polyamide covalent adaptable networks, methods for synthesizing the networks, and methods for reprocessing the networks. In embodiments, a dynamic siloxane-containing polyamide network comprises a polyamide network, portions of which are covalently linked via dynamic siloxane diamide linkages, each dynamic siloxane diamide linkage comprising a siloxane moiety positioned between two amide moieties and separated from each amide moiety by respective linker groups.

### CROSS REFERENCE TO RELATED APPLICATIONS

The present application claims priority to U.S. provisional patent application No. 63/774,273 that was filed Mar. 19, 2025, the entire contents of which are incorporated herein by reference.

### BACKGROUND

Due to their permanent network structures, thermosets offer numerous advantages over thermoplastics, including enhanced heat stability, solvent resistance, and improved physical and mechanical properties. However, the lack of recyclability and limited end-of-life scenarios for thermosets remain key challenges in contemporary polymer science and engineering. To address the recycling of thermosets, covalent adaptable networks (CANs), also called dynamic covalent polymer networks, have been developed that incorporate dynamic covalent bonds as cross-links in polymer networks. CANs may rearrange by one or more mechanisms in response to specific stimuli via dissociative reversion and/or associative exchange. Catalysis is commonly necessary to activate associative dynamic exchange reactions.

### SUMMARY

Provided are siloxane-containing polyamide covalent adaptable networks, methods for synthesizing the networks, and methods for reprocessing the networks.

Replacing non-recyclable thermosets with CANs that recover cross-link density after reprocessing will reduce waste and contribute to a circular polymer economy. Many CANs undergoing associative dynamic exchange require catalysis. External catalysis is used, but often leads to harmful effects, e.g., increased creep, accelerated material aging, and catalyst leaching. The present disclosure is illustrated by reference to an Example, below, that demonstrates internally catalyzed siloxane dynamic chemistry resulting from amides covalently linked through alkyl chains to siloxanes. Small-molecule studies show the formation of exchange products resulting from the reaction of two amide-containing siloxane molecules. The rubbery plateau modulus of each siloxane-exchange-based CAN is proportional to absolute temperature, indicating temperature-invariant cross-link densities characteristic of associative CANs. The alkyl length in the siloxane-containing monomer tunes the network cross-link density. Cross-link density recovery after reprocessing is achieved, with the required reprocessing time and temperature decreasing with increasing cross-link density. Stress relaxation is also faster with increasing cross-link density. The faster dynamics and reprocessability with increasing cross-link density arise because associative exchange is second order in siloxane (i.e., cross-linker) concentration. Capitalizing on this, melt extrusion of the highest cross-link density CAN is demonstrated, achieving the same cross-link density in extruded and compression-molded CANs. Using identical conditions, the next-highest cross-link density CAN is not extrudable.

In embodiments, a dynamic siloxane-containing polyamide network comprises a polyamide network, portions of which are covalently linked via dynamic siloxane diamide linkages, each dynamic siloxane diamide linkage comprising a siloxane moiety positioned between two amide moieties and separated from each amide moiety by respective linker groups.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1C. Small-molecule model study of an internally catalyzed siloxane exchange. (FIG. 1A) The reaction between Siloxane-C12 and Siloxane-C14 yielding the exchange product, (FIG. 1B) liquid chromatogram, and (FIG. 1C) mass spectrometry results of Siloxane-C14, Siloxane-C12, and the exchange product after reaction at 120° C. for 3 days under N₂ atmosphere.

FIGS. 2A-2C. Dynamic mechanical analysis results of the siloxane-containing polyamide networks as a function of reprocessing temperature: (FIG. 2A) n=1, (FIG. 2B) n=2, and (FIG. 2C) n=8 samples (see the n=1, 2, or 8 diester monomer in FIG. 9C.) Note that for the n=8 sample, reprocessing at 200° C. did not yield a recoverable consolidated material.

FIGS. 3A-3F. Dynamic mechanical analysis results of the siloxane-containing polyamide networks reprocessed at 250° C. as a function of reprocessing step. Tensile storage modulus and tan δ for (FIG. 3A) n=1, (FIG. 3B) n=2, and (FIG. 3C) n=8 samples. Cross-link density (calculated from Equation 1) of the siloxane-containing polyamide networks across their rubbery plateau as a function of processing step for: (FIG. 3D) n=1, (FIG. 3E) n=2, and (FIG. 3F) n=8 samples.

FIGS. 4A-4D. Normalized stress relaxation decay curves for (FIG. 4A) n=1, (FIG. 4B) n=2, and (FIG. 4C) n=8 samples. (FIG. 4D) Arrhenius temperature dependence of average stress relaxation times of the siloxane-containing polyamide networks, providing determinations of activation energy, Eₐ.

FIG. 5. Normalized stress relaxation decay curves of the siloxane network containing a mixture of n=1 and n=8 diester monomers at overall concentrations of siloxane and amide bonds equal to those of a network made with n=2 diester monomer.

FIGS. 6A-6C. Test of extrudability of (FIG. 6A) n=1 and (FIG. 6B) n=2 siloxane-containing polyamide samples. (FIG. 6C) Temperature dependence of the tensile storage modulus (E′) of the extruded n=1 sample in comparison with its 1^{st}-mold compression molded film.

FIG. 7. A schematic representation of an illustrative extrudable covalent adaptable network as disclosed herein.

FIG. 8. Schematic representation of a general siloxane exchange reaction with examples of external catalysts and the proposed amide linkage as an internal catalyst as described herein.

FIGS. 9A-9D. (FIG. 9A) Synthesis of illustrative siloxane-containing diester monomers with different alkyl spacer lengths. (FIG. 9B) The reaction between an amine and an ester yields an amide linkage, which can be leveraged to synthesize siloxane-containing polyamide networks as described herein and illustrated in FIG. 9C. (FIG. 9D) Images of compression-molded samples of the siloxane-containing polyamide networks.

### DETAILED DESCRIPTION

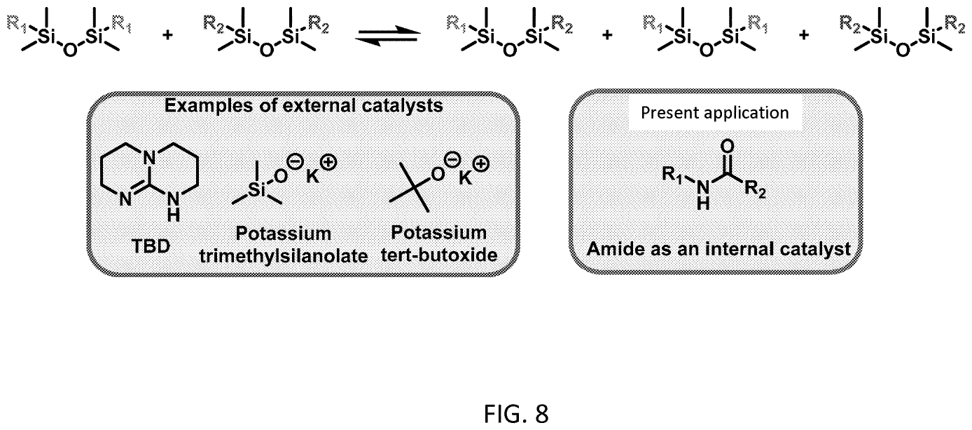

The present disclosure provides covalent adaptable networks (CANs) capable of hosting associative dynamic siloxane exchange reactions within the CANs which are internally catalyzed by amide moieties incorporated therein. (A generic siloxane exchange reaction is illustrated in the scheme shown in FIG. 8.) The present CANs (which may be referred to as siloxane-containing polyamide networks) may be synthesized by reacting a siloxane diester monomer (a component which forms dynamic siloxane diamide linkages), a diamine (a component which converts ester moieties, including in the siloxane diester monomer, to amide moieties), and an ester monomer (a component which forms polymer chains and/or additional crosslinks with amine moieties, including in the diamine). Illustrative conditions for inducing chemical reactions between these components to form the siloxane-containing polyamide networks are provided in the Example, below. The composition comprising the siloxane diester monomer, the diamine, and the ester monomer may be referred to as a siloxane-containing polyamide network precursor composition, which is also encompassed by the present disclosure.

The siloxane diester monomer comprises a siloxane moiety (—Si(R″)₂OSi(R″)₂—) and two ester moieties (—C(O)OR′). (In these moieties, the “—” represents a covalent bond to a portion of the siloxane diester monomer. Suitable R′ and R″ groups are provided below.) The siloxane moiety may be positioned between the two ester moieties. The siloxane moiety may be positioned between the two ester moieties and separated from each by respective alkyl groups. The siloxane diester monomer may be selected from those having the formula: R′OC(O)R″Si(R″)₂OSi(R″)₂R″C(O)OR′. In this formula, the R′ groups may be independently selected from alkyl groups (e.g., linear alkyl groups); the R″ groups may be independently selected from alkyl groups (e.g., linear alkyl groups) and aryl groups (e.g., those provided by methyl 4-vinylbenzoate, methyl 4-allyloxybenzoate, or methyl 2-methoxy-4-vinylbenzoate); and the R″ groups may be independently selected from hydrogen and alkyl groups (e.g., linear alkyl groups).

As demonstrated in the Example, below, the number of carbon atoms in the R″ groups affects the crosslink density in the siloxane-containing polyamide networks and thus, the number of carbon atoms may be selected on this basis. In embodiments, the R″ groups are independently selected linear alkyl groups having from 2 to 10 carbon atoms. This includes having 2, 3, 4, 5, 6, 7, 8, 9, or 10 carbon atoms.

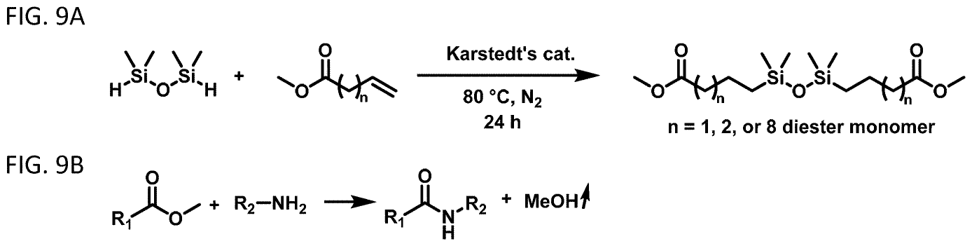

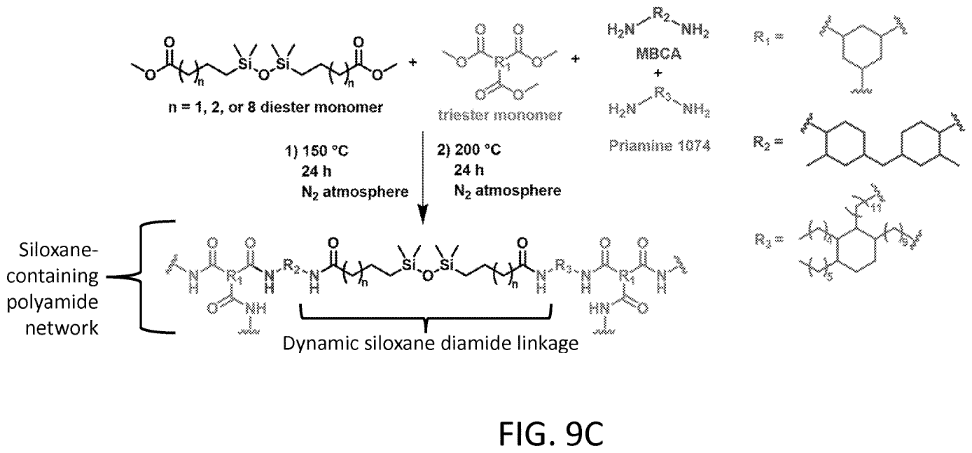

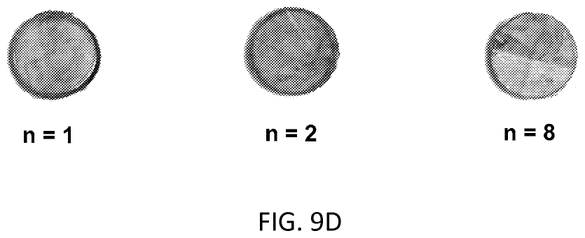

Illustrative siloxane diester monomers are shown in FIG. 9C. An illustrative method for synthesizing the siloxane diester monomers is provided in the Example, below (see FIG. 9A.). A single type, or multiple, different types of siloxane diester monomers may be used.

Further regarding the alkyl groups, alkyl groups generally encompass linear, branched, and cyclic alkyl groups in which the number of carbons may range from, e.g., 1 to 10, including 2, 3, 4, 5, 6, 7, 8, and 9. A cyclic alkyl group may be referred to as a cycloalkyl group. Cycloalkyl groups encompass those having one or more than one ring structure and those in which alkyl group(s) are bound to the ring structure(s). The alkyl group may be unsubstituted, by which it is meant the alkyl group contains no heteroatoms. The alkyl group may be substituted, by which it is meant an unsubstituted alkyl group in which one or more bonds to a carbon(s) or hydrogen(s) are replaced by a bond to a non-hydrogen, non-carbon atom. As noted above, in embodiments, R′, R″, and/or R″ groups may be selected from linear alkyl groups. In embodiments, the linear alkyl groups have from 1 to 10 carbon atoms. In embodiments, the linear alkyl groups are unsubstituted.

Further regarding the aryl groups, aryl groups generally encompass a monocyclic aryl group having one aromatic ring (e.g., phenyl) or a polycyclic group having more than one aromatic ring (e.g., two, three, etc. rings). Monocyclic aryl groups may be unsubstituted or substituted as described above with respect to alkyl groups. However, unsubstituted aryl groups encompass aromatic rings (e.g., phenyl) in which one or more bonds to a carbon(s) or hydrogen(s) are replaced by a bond to an unsubstituted alkyl group (e.g., an unsubstituted linear alkyl). In addition, substituted aryl groups encompass aromatic rings (e.g., phenyl) in which one or more bonds to a carbon(s) or hydrogen(s) are replaced by a bond to a substituted alkyl group. Thus, aryl groups include unsubstituted alkyl phenyl groups, e.g., as provided by methyl 4-vinylbenzoate, and substituted alkyl phenyl groups, e.g., as provided by methyl 4-allyloxybenzoate or methyl 2-methoxy-4-vinylbenzoate. Regarding polycyclic groups, neighboring aromatic rings may be fused or unfused. The aromatic rings of a polycyclic group may be unsubstituted or substituted as described above with respect to monocyclic aryl groups. As noted above, R″ groups may be selected from aryl groups. In embodiments, the aryl group is a phenyl group. In embodiments, the aryl group is an unsubstituted alkyl phenyl group. In embodiments, the aryl group is a substituted alkyl phenyl group.

The diamine comprises two amine moieties, which may be primary amine moieties (—NH₂, where the “—” represents a covalent bond to a portion of the diamine). The diamine may be selected from those having the formula: H₂NRNH₂, wherein R is selected from alkyl groups (e.g., cycloalkyl groups), ether groups, and aryl groups. Regarding alkyl and aryl groups, these have been defined above. In embodiments, R is selected from fluoroalkyl groups. Regarding ether groups, in embodiments, the ether group is a polyether group e.g., poly(ethylene glycol), poly(propylene glycol), or poly(tetramethylene oxide). A single type, or multiple, different types of diamines may be used. Illustrative diamines are also shown in FIG. 9C. Many suitable diamines are commercially available, including those shown in FIG. 9C.

The ester monomer comprises at least one ester moiety. Generally, multiple ester moieties are present, thereby rendering the ester monomer multifunctional and capable of reacting with more than one amine moiety, including those in the diamine. In this way, the ester monomer may act as an additional crosslinking unit in the present siloxane-containing polyamide networks. Illustrative multifunctional ester monomers may be selected from those having the formula: (R^{V}OC(O))ₙR^{IV} wherein the R^{V} groups are independently selected from alkyl groups (e.g., linear alkyl groups), R^{IV} is selected from alkyl groups (e.g., linear alkyl groups, cycloalkyl groups) and aryl groups, and wherein n is greater than 2 (e.g., 3, 4). Alkyl and aryl groups have been defined above. A single type, or multiple, different types of ester monomers may be used. An illustrative triester monomer is also shown in FIG. 9C. An illustrative method for synthesizing the triester monomer is provided in the Example, below.

The siloxane-containing polyamide network precursor composition may include various relative amounts of the siloxane diester monomer, the diamine, and the ester monomer, depending upon the desired properties for the siloxane-containing polyamide network and its application. Illustrative relative amounts are provided in the Example, below (see Table A). Although in some embodiments other components may be included in the siloxane-containing polyamide network precursor composition, no external catalyst is required. Thus, the siloxane-containing polyamide network precursor composition (and the resulting network) may be considered to be free of any other catalyst other than the amide moieties incorporated within the siloxane-containing polyamide network itself. This includes the siloxane-containing polyamide network precursor composition (and the resulting network) being free of 1,5,7-triazabicyclo[4.4.0]dec-5-ene (TBD), potassium tert-butoxide (tBuOK), potassium trimethyl silanolate (SiMe₃OK), 7-methyl-1,5,7-triazabicyclo(4.4.0) dec-5-ene (MeTBD), 1,8-diazabicyclo[5.4.0]undec-7-ene (DBU),4-dimethylamino-pyridine (DMAP), and tetramethylammonium siloxanolate (TMAS). In addition, in embodiments, the siloxane-containing polyamide network precursor composition may consist of the siloxane diester monomer(s), the diamine(s), and the ester monomer(s). No solvent or other components are required.

The resulting siloxane-containing polyamide network comprises a polyamide network, portions of which are covalently linked via dynamic siloxane diamide linkages. Under appropriate conditions, the dynamic siloxane diamide linkages undergo internally catalyzed (via the amide moieties of other dynamic siloxane diamide linkages in the polyamide network) siloxane exchange reactions. The dynamic siloxane diamide linkages comprise a siloxane moiety (—Si(R″)₂OSi(R″)₂—) and two amide moieties (—HNC(O)—). In the siloxane moiety, the “—” represents a covalent bond to a portion of the dynamic siloxane diamide linkage and R″ is as defined above with respect to the siloxane diester monomer. In the amide moieties, one “—” represents a covalent bond to a portion of the dynamic siloxane diamide linkage while the other represents a covalent bond to a portion of the polyamide network. The siloxane moiety may be positioned between the two amide moieties and separated from each by respective linker groups (i.e., R″ groups). The dynamic siloxane diamide linkages may have the formula:—HNC(O)R″Si(R″)₂OSi(R″)₂R″C(O)NH—. In this formula, the “—” represents a covalent bond to a portion of the polyamide network and R″ and R″ are as defined above with respect to the siloxane diester monomer. The chemical composition of the polyamide network depends upon the selected diamine and ester monomer. It comprises a polymeric chain of monomeric units linked by amide bonds, but depending upon the other groups in the diamine and ester monomer, a variety of polyamide networks are encompassed.

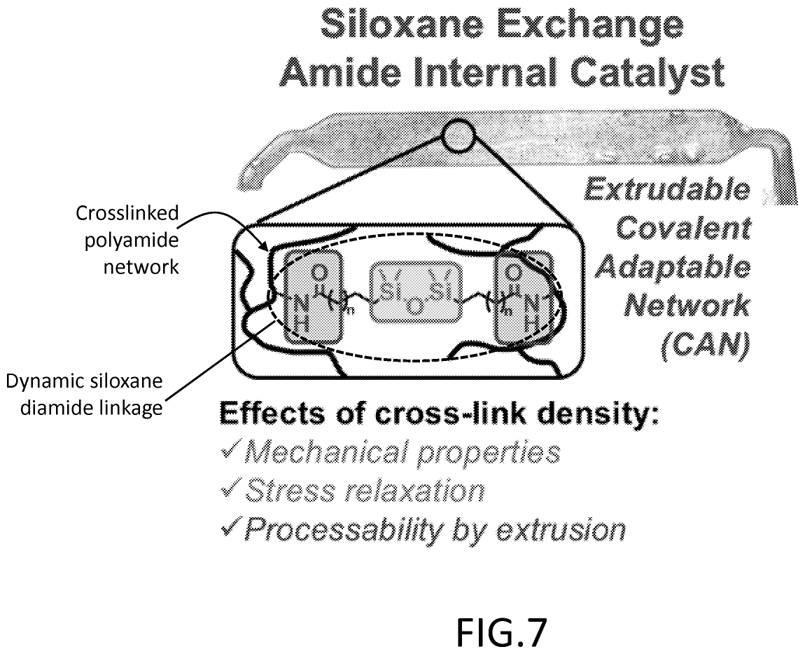

An illustrative siloxane-containing polyamide network is schematically shown in FIG. 7. More specifically, an illustrative siloxane-containing polyamide network is shown in FIG. 9C. The crosslinked polyamide network and the dynamic siloxane diamide linkages are labelled.

The present siloxane-containing polyamide network may also be described as the polymerization product of any of the disclosed siloxane diester monomers, diamines, and ester monomers. Since the Examples, below, show that the polymerization reactions proceed essentially to completion, the siloxane-containing polyamide network itself may be accurately identified by reference to the reactants used to produce it, realizing that the precise chemical formula of the network changes due to the polymerization reactions.

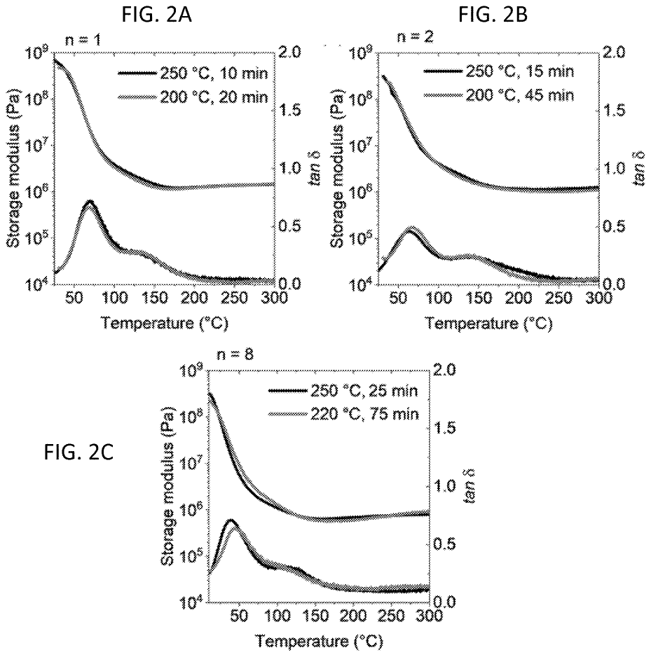

The present siloxane-containing polyamide networks may be reprocessed by heating them from a temperature at which siloxane exchange reactions of the dynamic siloxane diamide linkages do not occur (at all or to any appreciable extent), such as room temperature, to an elevated temperature at which the siloxane exchange reactions occur (including at significantly enhanced rates). The heating may be carried out at a reprocessing temperature and a reprocessing time, both of which are desirably minimized for applications in which fast reprocessing is important. The specific reprocessing temperatures and times depend upon the particular siloxane-containing polyamide network, but illustrative reprocessing temperatures include those no greater than 275° C., no greater than 250° C., no greater than 225° C., no greater than 200° C., or a range of between any of these values. Illustrative times include those no greater than 1 hour, no greater than 45 minutes, no greater than 30 minutes, no greater than 15 minutes, or a range of between any of these values. Reprocessing may involve reshaping (e.g., via compression molding or extrusion molding) and cooling, e.g., to room temperature. A single reprocessing cycle refers to a single round of heating, reshaping, and cooling. Notably, the Example below demonstrates that embodiments of the present siloxane-containing polyamide networks may be reprocessed under these conditions to provide a reprocessed network with full recovery of crosslinking density (as compared to the initial network prior to any reprocessing). (See FIGS. 2A-2C, 3A-3F, 6A-6C, and Table 1.)

The present siloxane-containing polyamide networks may be characterized by properties including crosslinking density after reprocessing. As noted above, the siloxane-containing polyamide network may be characterized by full recovery of crosslinking density after being subject to one or more reprocessing cycles. Recovery of crosslinking density may be measured by measuring tensile storage modulus E′ values and glass transition temperature T_{g} values using dynamic mechanical analysis (DMA) as described in the Example below. Full recovery means that the E′ and/or T_{g} values for the reprocessed network are the same (within error) of the initial network prior to any reprocessing. The reprocessing cycle may refer to conditions as used in the Example below, involving either compression molding or extrusion molding. Full recovery of crosslinking density may be obtained after one, two, or more cycles of reprocessing.

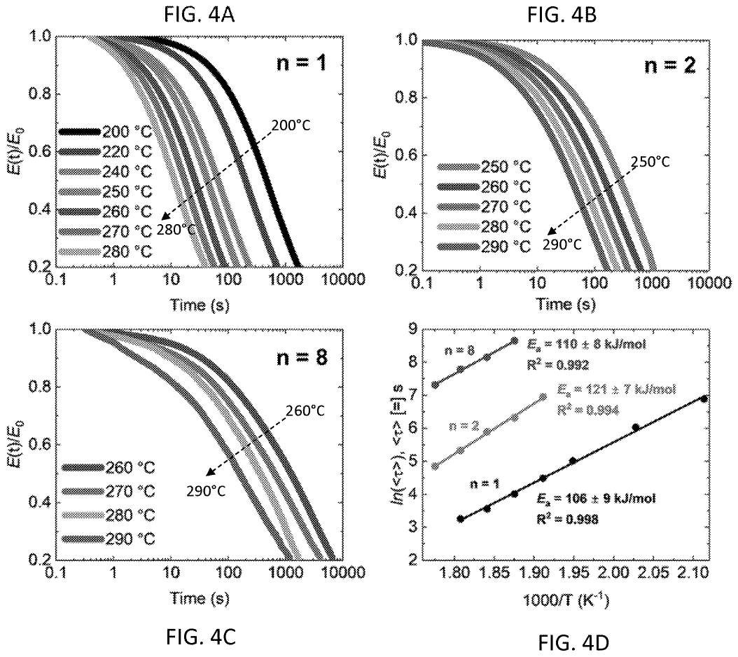

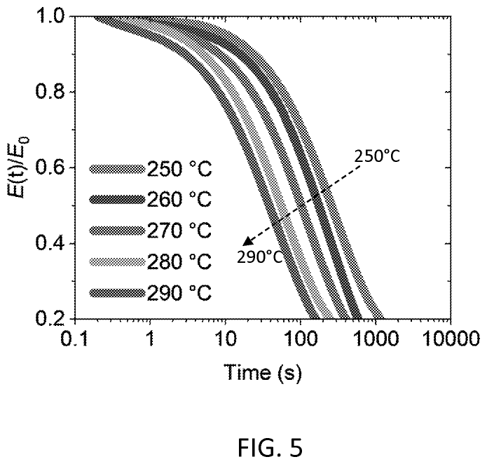

The present siloxane-containing polyamide networks may be characterized by other properties including average stress relaxation time as described in the Example, below. (See FIGS. 4A-4D, 5, and Table 2.)

### Example

### Introduction

This Example shows a pathway designed to achieve internally catalyzed, siloxane-exchange-based CANs. The approach is based on using an amide group as a secondary linkage to create a strong pathway for internally catalyzing siloxane exchange. First, a small-molecule study was conducted that demonstrated proof of concept for internal amide-catalyzed siloxane exchange. The aim was to gain a deeper understanding of how cross-link density (and consequently, the concentration of the internal catalysis groups and the exchangeable siloxane groups) affects the properties and reprocessability of the CANs, along with the exchange dynamics and stress relaxation. To evaluate these effects, siloxane-containing diester monomers with different alkyl spacer lengths were synthesized. By reacting the diester monomers and a triester cross-linker with diamine monomers, amide linkages were generated that simultaneously served as the cross-links and the internal catalyst for the siloxane exchange. Then, the reprocessability was investigated, and it was demonstrated that the siloxane-based CANs can be reprocessed multiple times without a loss of cross-link density. With increasing siloxane and amide concentrations in the CANs, i.e., with increasing cross-linker concentration, the dynamic exchange became progressively faster. Taking advantage of this dependence of the speed of the dynamic chemistry on cross-link density, it was further demonstrated that the highest cross-link density CAN (with the fastest stress relaxation) underwent facile melt extrusion with full retention of properties associated with cross-link density. In summary, a siloxane-based CAN system with inherently tunable internal catalyst and exchange group concentrations was successfully designed, providing a systematic way to study the fundamental aspects of associative CANs containing internal catalysts and to design an associative CAN for facile extrusion-based reprocessing without external catalysis.

### Experimental

Materials. Reagents and starting materials were used as received. 1,1,3,3-tetramethyldisiloxane (97%), tetradecylamine (C14-amine, 95%), dodecylamine (C12-amine, 95%) Chloroform (CHCl₃, HPLC grade), 1,3,5-cyclohexanetricarboxylic acid (95%), 4,4-methylenebis(2-methylcyclohexylamine) (MBCA, technical grade), platinum(0)-1,3-divinyl-1,1,3,3-tetramethyldisiloxane (Karstedt's catalyst, 2 wt % in xylene), methyl-3-butenoate (n=1 alkene, 95%), methyl-4-pentenoate (n=2 alkene, 95%), methyl-10-undecenoate (n=8 alkene, 95%), sulfuric acid (H₂SO₄, 98%) methanol (MeOH, HPLC grade) chloroform-d (CDCl₃, 99.8% atom D) were purchased from Sigma-Aldrich. Priamine™ 1074 was kindly provided by Croda.

Synthesis of siloxane diester monomers. 1,1,3,3-tetramethyldisiloxane (1 equiv.) and the respective alkene (2 equiv.) were mixed in a septum-sealed vial. The mixture was bubbled with N₂ for 15 min, and Karstedt's catalyst (10 ppm w.r.t. siloxane groups) was added. The progression of the reaction was monitored by ¹H NMR spectroscopy by monitoring the disappearance of the peaks at δ=5.20 ppm and d=5.90 ppm corresponding to the terminal alkene protons. The resulting product was used without further purification.

Synthesis of n=1 diester monomer. This compound was synthesized following the procedure described herein with the n=1 alkene (7.4 g, 74.4 mmol alkene group) 1,1,3,3 tetramethyldisiloxane (5.0 g, 74.4 mmol Si—H group) and Karstedt's catalyst (15 mg, 0.00074 mmol, 10 ppm) to afford a pale yellow oil (12.4 g, 100%). n=1 diester monomer: ¹H NMR (600 MHz, CDCl₃) δ 3.80-3.62 (m, 6H), 2.35 (t, J=7.4 Hz, 4H), 1.72-1.63 (m, 4H), 0.60-0.52 (m, 4H), 0.16-0.05 (m, 12H). Density (p=0.89 g/mL)

Synthesis of n=2 diester monomer. This compound was synthesized following the procedure described herein with the n=2 alkene (8.7 g, 74.4 mmol alkene group) 1,1,3,3 tetramethyldisiloxane (5.0 g, 74.4 mmol Si—H group) and Karstedt's catalyst (15 mg, 0.00074 mmol, 10 ppm) to afford a pale yellow oil (13.7 g, 100%). n=2 diester monomer: ¹H NMR (500 MHZ, CDCl₃) δ 3.63 (s, 6H), 2.28 (t, J=7.5 Hz, 4H), 1.61 (p, J=7.5 Hz, 4H), 1.31 (dtd, J=9.2, 7.8, 5.7 Hz, 4H), 0.52-0.45 (m, 1H), 0.01 (s, 12H). p=0.94 g/mL

Synthesis of n=8 diester monomer. This compound was synthesized following the procedure described herein with the n=8 alkene (11.8 g, 59.6 mmol alkene group) 1,1,3,3 tetramethyldisiloxane (4.0 g, 59.6 mmol Si—H group) and Karstedt's catalyst (10 mg, 0.00059 mmol, 10 ppm) to afford a pale yellow oil (15.8 g, 100%). n=8 diester monomer: ¹H NMR (600 MHZ, CDCl₃) δ 3.69 (s, 6H), 2.32 (t, J=7.6 Hz, 6=4H), 1.63 (td, J=13.0, 11.4, 5.8 Hz, 4H), 1.30 (td, J=12.4, 11.6, 5.5 Hz, 24H), 0.51 (t, J=7.7 Hz, 4H), 0.05 (s, 12H). p=0.98 g/mL

Synthesis of small molecule siloxanes. The n=8 diester monomer (1 equiv.) and the corresponding amine (5 equiv.) were mixed in a septum-sealed vial. N₂ was bubbled into the reaction mixture, and an inert N₂ atmosphere was set up using a syringe equipped with an N₂ balloon. The reaction mixture was heated at 120° C. for 72 h. The crude product was purified by vacuum distillation using a Kugelrohr apparatus at 50° C. and 10 mbar.

Synthesis of Siloxane-C14. This compound was synthesized following the procedure described herein with the n=8 diester monomer (500 mg, 1.88 mmol ester group) and tetradecylamine (1000 mg, 4.71 mmol NH₂ group) to afford a pale yellow waxy solid (650 mg, 77.4%). Siloxane-C14: ¹H NMR (500 MHZ, CDCl₃) δ 5.47 (t, J=5.8 Hz, 2H), 3.21 (td, J=7.3, 5.8 Hz, 4H), 2.15-2.09 (m, 4H), 1.59 (p, J=7.8, 7.2 Hz, 4H), 1.46 (p, J=7.0 Hz, 4H), 1.25 (d, J=19.1 Hz, 64H), 0.85 (t, J=6.9 Hz, 6H), 0.46 (t, J=7.6 Hz, 4H), −0.00 (s, 12H). Hi-Res MS (ESI): m/z found [M−H⁺] for C₅₄H₁₁₂N₂O₃Si₂⁺893.83 (calcd. 893.67).

Synthesis of Siloxane-C12. This compound was synthesized following the procedure described herein with the n=8 diester monomer (500 mg, 1.88 mmol ester group) and dodecylamine (873 mg, 4.71 mmol NH₂ group) to afford a pale yellow waxy solid (540 mg, 68.7%). Siloxane-C12: ¹H NMR (500 MHZ, CDCl₃) δ 5.47 (d, J=5.9 Hz, 2H), 3.21 (td, J=7.3, 5.8 Hz, 4H), 2.12 (t, J=7.6 Hz, 4H), 1.59 (p, J=7.4 Hz, 4H), 1.46 (p, J=7.2 Hz, 4H), 1.25 (d, J=17.7 Hz, 60H), 0.85 (t, J=6.9 Hz, 6H), 0.46 (t, J=7.6 Hz, 4H), −0.00 (s, 23H). Hi-Res MS (ESI): m/z found [M-H⁺] for C₅₀H₁₀₄N₂O₃Si₂⁺837.78 (calcd. 837.56).

Synthesis of triester monomer. 1,3,5-cyclohexanetricarboxylic acid (12.0 g, 55.5 mmol), sulfuric acid (H₂SO₄, 10.9 g, 2 equiv, 111 mmol), and methanol (MeOH, 100 mL) were dissolved in a round-bottomed flask, and the mixture was refluxed for 24 h. The reaction mixture was extracted with dichloromethane (3×30 mL). The combined organic extracts were washed with sat. NaHCO₃ (3×50 mL) and dried over MgSO₄. The organic solvents were evaporated under reduced pressure to afford a white waxy solid (12.2 g, 85.4%). Triester monomer: ¹H NMR (500 MHZ, CDCl₃) δ 3.71 (s, 9H), 2.45-2.24 (m, 6H), 1.61-1.50 (m, 3H).

Synthesis of siloxane-containing polyamide network (n=1, n=2, and n=8 networks). The procedure described here is representative of the n=8 siloxane-containing polyamide network sample (see Table A, below, for formulations of n=1 and n=2 samples). The n=8 diester monomer (1000 mg, 3.76 mmol ester group), triester monomer (365 mg, 4.23 mmol ester group), MBCA (478 mg, 4.00 mmol NH₂ group), and Priamine 1074 (1100 mg, 4.00 mmol NH₂ group) were mixed in a septum-sealed vial. N₂ was bubbled into the reaction mixture for 20 min while heating at 80° C. to facilitate dissolution of the triester monomer. An inert N₂ atmosphere was set up using a syringe equipped with N₂ balloon, and the mixture was heated to 120° C. for 3 h, followed by 150° C. for 24 h, then followed by 200° C. for 24 h. The network samples were post-cured at 250° C. for 24 h under inert N₂ atmosphere. After cooling to room temperature, the network was cut into millimeter-sized pieces for characterization and reprocessing.

TABLE A
Monomer formulation for making the
siloxane-containing polyamide CANs.

| | Diester | Triester | MBCA | Priamine 1074 |
|---|---|---|---|---|
| Sample | (mg) | (mg) | (mg) | (mg) |
| n = 1 | 1000 | 580 | 757 | 1740 |
| n = 2 | 1000 | 534 | 699 | 1610 |
| n = 8 | 1000 | 364 | 479 | 1100 |
| Mixture of n = 1 | 816 mg (n = 1) | 534 | 699 | 1610 |
| and n = 8 | 170 mg (n = 8) | | | |

Exchange reaction between small molecule Siloxane C12 and Siloxane C14. Siloxane-C12 (200 mg, 0.24 mmol) and Siloxane-C14 (215 mg, 0.24 mmol) were mixed in a GCMS vial. The mixture was heated to 120° C. for 72 h under an inert N₂ atmosphere. A 10 μg/mL solution of the crude reaction mixture in 9:1 MeOH/CHCl₃ was prepared for liquid chromatography-mass spectrometry (LCMS) analysis.

¹H-NMR spectroscopy. ¹H NMR spectra were recorded at room temperature using a Bruker AVANCE III 500 MHz NMR spectrometer. Chemical shifts were quoted in ppm relative to tetramethylsilane (TMS), using the residual solvent peak as the reference standard.

Fourier Transform Infrared (FTIR) Spectroscopy. ATR-FTIR spectroscopy was performed using a Bruker Tensor 37 FTIR spectrophotometer with a diamond/ZnSe attachment. Samples were scanned at room temperature with a 4 cm⁻¹ resolution over 4000-600 cm⁻¹ range.

Liquid chromatography-mass spectrometry (LCMS). Diluted samples were injected on a 1290 Infinity II UHPLC System (Agilent Technologies Inc., Santa Clara, California, USA) onto an Acquity Premier C18 column (1.9 μm, 150×2.1 mm) (Waters Corporation, Milford, Massachusetts, USA) for reversed-phase chromatography which was maintained at 50° C. with a constant flow rate at 0.200 mL min⁻¹, using a gradient of mobile phase A (9:1 water/methanol, 10 mM ammonium acetate, 0.2 mM ammonium fluoride) and mobile phase B (2:3:5 acetonitrile/methanol/isopropanol, 10 mM ammonium acetate, 0.2 mM ammonium fluoride). The gradient was programmed as follows: 0-1 min, 95% B; 1-3 min, 95-96% B; 3-6 min, 96-100% B; 6-10 min, hold 100% B; 10-10.10 min, 100-95% B; 10.10-13 min, hold 95% B. After C18 chromatography, the eluents passed through a 1260 Infinity II multi-wavelength detector (Agilent Technologies Inc., Santa Clara, California, USA) prior to MS detection. The absorbance wavelength was set at 214 nm with a 10-nm bandwidth. “MS-Only”, positive ion mode acquisition was conducted on the samples on an Agilent 6545 quadrupole time-of-flight mass spectrometer (Q-TOF LC-MS) equipped with a JetStream ionization source. The source conditions were as follows: gas temperature, 200° C.; drying gas flow, 12 L min⁻¹; nebulizer, 50 psi; sheath gas temperature, 300° C.; sheath gas flow, 12 L min⁻¹; VCap, 2500 V; fragmentor, 120 V; skimmer, 65 V; and oct 1 RF, 750 V. The acquisition rate in MS-Only mode was 5 spectra per see between 40-1700 m/z range. The reference ion mass solution was introduced in the ion source using a separate quaternary HPLC pump containing m/z 121.050873 and m/z 922.009798 as reference masses in positive ion mode. Agilent (.d) files were imported to MassHunter Qualitative Analysis software (v. 10) where peak areas and mass spectra were extracted for each dataset.

Reprocessing of siloxane-containing polyamide network by compression molding. The siloxane-containing polyamide CANs were reprocessed into bulk films using a PHI press (Model 0230C-X1). The CANs were cut into millimeter-sized pieces, and the pieces were placed between two metal plates, a ~1 mm thick spacer, and a layer of Kapton tape. The network pieces were compression molded into ~1 mm thick films at 200° C., 220° C., or 250° C. for the suitable reprocessing time (vide infra) under 10-ton ram force (~16 MPa). The samples were subsequently cooled to room temperature in a cold compression mold under 1-ton ram force for 5 min. The obtained film is called the 1^{st}-mold sample. A sample of this film was cut into small pieces and reprocessed under similar conditions to give the 2^{nd}-mold sample.

Reprocessing of siloxane-containing polyamide network by extrusion. A Thermo Scientific Haake Minilab 3 twin-screw extruder was used to perform proof-of-concept extrusion of the n=1 and n=2 samples that had been cut into small pieces. The extruder was operated in circulation mode to mimic a pseudo-injection molding process and preheated to 260° C. under constant N₂ flow from the hopper. ~5 g of the pieces were fed into the hopper and circulated through the screws at 260° C. and 5 rpm, whereupon the material filled a backflow channel connected to the twin-screw extruder. After feeding, the material was subjected to continuous circulation for 10 min under constant N₂ flow. Subsequently, the lid of the extruder was opened, and the material was collected.

Dynamic mechanical analysis (DMA). Tensile storage modulus (E′), tensile loss modulus (E″), and the damping ratio (tan δ=E″/E′) of rectangular samples (8 mm×3 mm×1 mm) were obtained as functions of temperature using a TA Instruments RSA-G2 Solids Analyzer operated in tension mode at a frequency of 1 Hz and 0.03% oscillatory strain. All samples were equilibrated at the temperature of interest for 5 min before commencing an experiment. Samples were heated from −25° C. to 300° C. at a rate of 3° C./min under N₂ atmosphere.

For tension-mode stress relaxation studies, samples were equilibrated for 5 min at the test temperature. Then, a constant 5% strain was applied, and the stress relaxation modulus (E (t)) was recorded as a function of time until samples had relaxed at least 80% of their initial values.

Differential scanning calorimetry (DSC). A TA Instruments Q200 was used to evaluate the glass transition temperature (T_{g}). Samples were first heated to 200° C. at a rate of 20° C./min and allowed to remain for 5 min before cooling to −10° C. at a rate of −20° C./min. Values of T_{g} were determined using the ½ΔCp method from a second heating ramp from −10° C. to 300° C. at a heating rate of 10° C./min.

Thermogravimetric analysis (TGA). TGA was done using a Mettler Toledo TGA/DSC 3+. Samples were heated under a N₂ atmosphere from 25° C. to 650° C. at a 5° C./min heating rate. The change in weight was recorded as a function of temperature. For isothermal studies, samples were heated to 250° C., and the change in weight was recorded as a function of time over 90 min.

Swelling tests. The mass of dry samples was recorded. Samples were then each placed in ~20-mL scintillation vials filled with chloroform. The networks were allowed to swell for 7 days, whereupon the solvent was decanted. Samples were immediately dried by gentle patting with a paper towel and subsequently weighed. Finally, samples were dried in a vacuum oven at 90° C. for 7 days to remove residual solvent and then weighed again. Gel contents and swelling ratios were calculated according to Equation 4 and 5:

$$gel content \% = \frac{{m}_{d}}{{m}_{0}} \times 100 \% \qquad ( 4 )$$

$$swelling ratio = \frac{( {m}_{s} - {m}_{d} )}{{m}_{d}} \times 100 \% \qquad ( 5 )$$

where m₀ is the initial mass before swelling, mₛ is the mass after swelling prior to vacuum drying, and ma is the mass of the swelled sample after vacuum drying.

### Results and Discussion

Small-molecule discovery of internal amide-catalyzed siloxane exchange. It was hypothesized that affixing a functional group containing a secondary amine in close proximity to a siloxane bond would provide a pathway to achieve internally catalyzed siloxane exchange. In addition, it was hypothesized that an amide group may provide an ideal secondary amine source as well as provide a facile platform for building the polymer network.

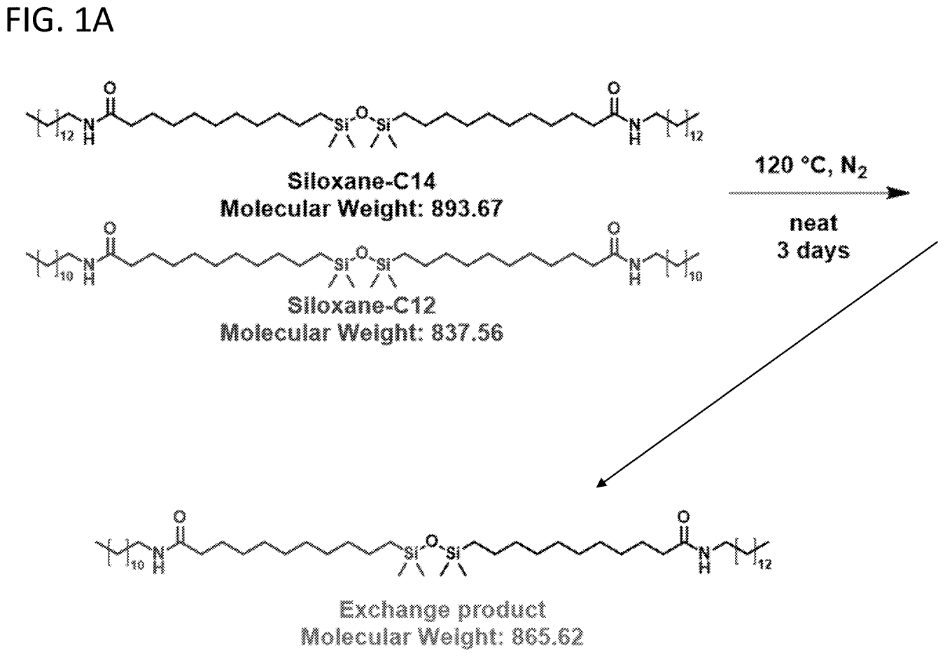

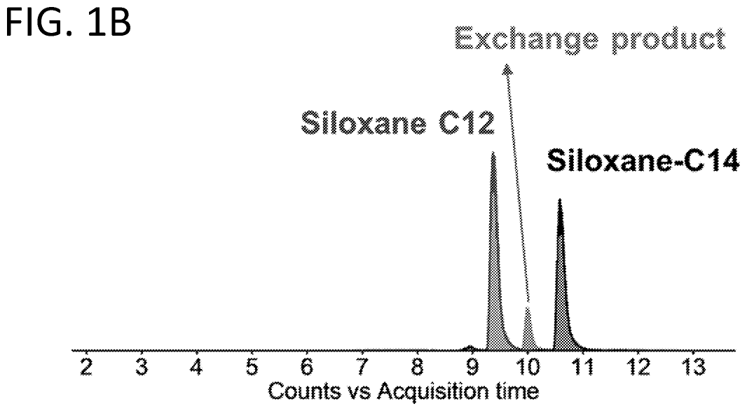

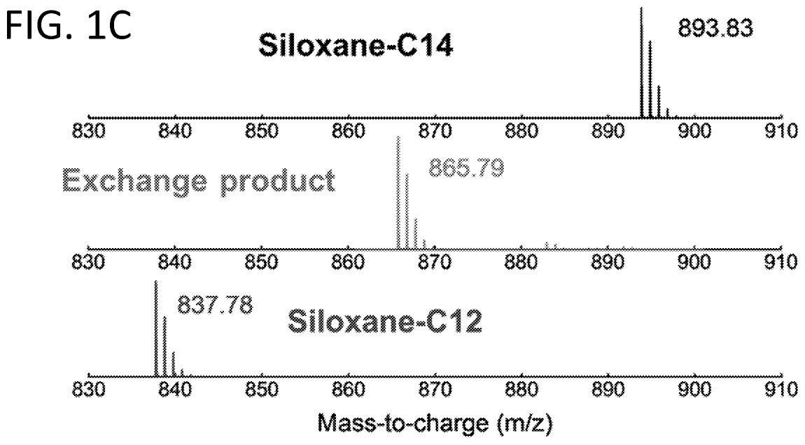

First, the inventors sought to demonstrate proof-of-concept small-molecule studies of a neighboring amide-catalyzed siloxane exchange reaction. Two model compounds, Siloxane-C12 (calcd. 837.56 m/z, found 837.56 m/z) and Siloxane-C14 (calcd. 893.67 m/z, found 893.83 m/z) were synthesized, both containing a siloxane group covalently bonded to two amide groups on the ends of the alkyl spacer group (see FIG. 1A, ¹H-NMR characterization data not shown). Because Siloxane-C12 and Siloxane-C14 are nearly identical (with the addition of two methylene groups in each arm of Siloxane-C14), they are highly soluble with each other, allowing for the study of the exchange reaction in bulk. A stoichiometrically balanced mixture of Siloxane-C14 and Siloxane-C12 at 120° C. was heated for 3 days and then subjected the mixture to liquid chromatography-mass spectrometry (LCMS) for characterization. The liquid chromatogram (FIG. 1B) displayed three peaks corresponding to the Siloxane-C12, Siloxane-C14, and an intermediate peak between Siloxane-C12 and Siloxane-C14. Mass spectrometry analysis revealed that the intermediate peak corresponded to m/z of 865.79 (FIG. 1C). This is consistent with the molecular weight of the theoretical exchange product, with one arm having a C₁₂ moiety and the opposite arm having a C14 moiety (calcd. 865.62 m/z). Therefore, it was successfully demonstrated, for the first time, that a small-molecule siloxane covalently bonded with an amide group may undergo an exchange reaction without an external catalyst.

Synthesis and characterization of siloxane-containing polyamide CANs. Having shown that a neighboring, covalently bonded amide group can catalyze a siloxane exchange, next, a polymer network was constructed and analyzed. In the current study, the inventors sought to understand the effect of alkyl spacer length between the siloxane and amide group on the dynamics of the siloxane exchange reaction at a polymer network level. Symmetrical siloxane-containing diester monomers were prepared using a Pt-catalyzed hydrosilylation reaction between 1,1,3,3-tetramethyldisiloxane and a terminal-alkene-containing ester with different alkyl spacer lengths (see FIG. 9A). Three diester monomers were prepared with n=1, n=2, and n=8, each having 3, 4, and 10 methylene groups, respectively, between the siloxane and internal catalyst group (the terminology will be kept constant, using n=1, n=2, and n=8 throughout this Example). ¹H-NMR spectra and FTIR spectra of the diester monomers were obtained, showing complete conversion of the terminal alkene (5.20 and 5.90 ppm in the ¹H-NMR spectra; data not shown), and the retention of the ester groups (~1750 cm⁻¹ in the FTIR spectra, data not shown). Notably, the synthesis of siloxane-containing diester monomers utilized highly efficient Pt-catalyzed hydrosilylation chemistry, resulting in pure monomers that require no further purification at very high yields, thereby enhancing the commercial scale-up of this chemistry.

Then, the polymer network was synthesized by reacting the respective diester monomer with a triester cross-linker (characterization of the triester cross-linker was also carried out, data not shown) and difunctional amines. Because the reaction between an ester and amine generates an amide (FIG. 9B), the polymer networks were constructed with amide repeat units that simultaneously served as the cross-links and the internal catalyst group. Priamine 1074 and 4,4-methylenebis(2-methylcyclohexylamine) (MBCA) were chosen due to their aliphatic structures (for monomer formulation, see Table A). FTIR characterization of the networks (data not shown) showed very low levels of the unreacted ester group (~1750 cm⁻¹), indicating high conversions of the ester groups. FTIR spectra also showed a broad peak at ~3300 cm⁻¹, indicating the existence of a —NH— functional group, and a peak at ~1640 cm⁻¹, corresponding to an amide carbonyl group. Swelling tests also indicated high gel contents >92% (see Table B, below), confirming the cross-linked nature of the samples. The glass transition temperature (T_{g}) values of the siloxane-containing polyamide samples were also measured (see Table 1; the DSC heat flow curves are not shown). An increase in T_{g} was observed with decreasing alkyl spacer length in the siloxane-containing diester monomer. This gave an initial indication of an increase in cross-link density with decreasing alkyl spacer length (the T_{g} of a polymer network generally increases with increasing cross-link density.) The thermal stability of the materials was also measured by TGA (data not shown), showing a T_{d5%} of 423-432° C. (see Table 1), indicative of remarkable thermal stability, among the highest of siloxane-based CANs, and comparable to fully aliphatic polyethylene CAN materials.

TABLE B
Swelling ratio and gel contents of the siloxane-containing CANs.

| Sample | | Swelling ratio (%) | Gel fraction (%) |
|---|---|---|---|
| n = 1 | As synthesized | 236 | 96 |
| | 1^{st} mold | 289 | 94 |
| | 2^{nd} mold | 276 | 95 |
| n = 2 | As synthesized | 387 | 93 |
| | 1^{st} mold | 421 | 93 |
| | 2^{nd} mold | 471 | 94 |
| n = 8 | As synthesized | 512 | 91 |
| | 1^{st} mold | 588 | 92 |
| | 2^{nd} mold | 567 | 92 |

TABLE 1
Rubbery plateau, tensile storage modulus (E′, taken to be equivalent
to E in the rubbery plateau region) of the siloxane-containing
polyamide networks as functions of reprocessing step, and thermal
properties of the siloxane-containing polyamide networks.

| | | |
|---|---|---|
| E′ at 260° C. [MPa] | T_{g}^{a} | T_{d5%}^{b} |

| Sample | 1^{st} mold | 2^{nd} mold | [° C.] | [° C.] |
|---|---|---|---|---|
| n = 1 | 1.36 ± 0.07 | 1.39 ± 0.06 | 30 ± 1 | 423 |
| n = 2 | 1.04 ± 0.05 | 1.00 ± 0.04 | 21 ± 1 | 425 |
| n = 8 | 0.76 ± 0.07 | 0.77 ± 0.06 | 6 ± 1 | 432 |

^{a}T_{g} midpoint, measured using differential scanning calorimetry and determined using the ½ ΔCₚ method;
^{b}T at 5% mass loss, determined from thermogravimetric analysis.

Reprocessing of siloxane-containing polyamide CANs. The reprocessability of the siloxane-containing polyamide networks was characterized by compression molding. First, the optimal conditions to reprocess the CANs into robust films with full maximum attainable cross-link density were investigated by modifying the time and temperature (T) of compression molding (FIGS. 2A-2C). Intriguingly, the CAN with the highest cross-link density, n=1 system, can be reprocessed at the lowest T (200° C.) and the shortest time (20 min), followed by n=2 system, which required 45 min at 200° C. for reprocessing. The n=8 system did not yield a recoverable consolidated material at 200° C., indicating unsuccessful reprocessing at this temperature. For the n=8 system, full recovery of cross-link density was achieved by reprocessing at 220° C. for 75 min. To establish a baseline of equal conditions for subsequent studies, all systems were reprocessed at 250° C., and it was verified that cross-link density recovery was achieved under this condition (isothermal TGA indicated less than 0.5% mass loss at 250° C. (data not shown), which may be attributable to the desorption of moisture in the sample, hence reprocessing at 250° C. was not impacted by thermal degradation). According to Flory's ideal rubber elasticity theory, the tensile modulus, E, of a cross-linked polymer network in the rubbery plateau is proportional to the cross-link density, v, and absolute temperature:

$$E = 3 vRT \qquad ( 1 )$$

where R is the ideal gas constant, and in the rubbery plateau region, E is approximately equal to the tensile storage modulus (E′) as measured by dynamic mechanical analysis. It was observed that E′ increased with decreasing alkyl spacer length (Table 1), indicating an increase in cross-link density. This observation is consistent with the screening studies of the optimal compression-molding condition, which provided an indication that the siloxane exchange dynamics increased with increasing cross-link density. Such behavior is counterintuitive, but the inventors believe that a higher cross-link density made the siloxane dynamic chemistry and stress relaxation more rapid, arising from the increasing dominance of the associative exchange mechanism at higher cross-link density. Subsequent sections will provide further commentary on this correlation in the internally catalyzed siloxane CANs.

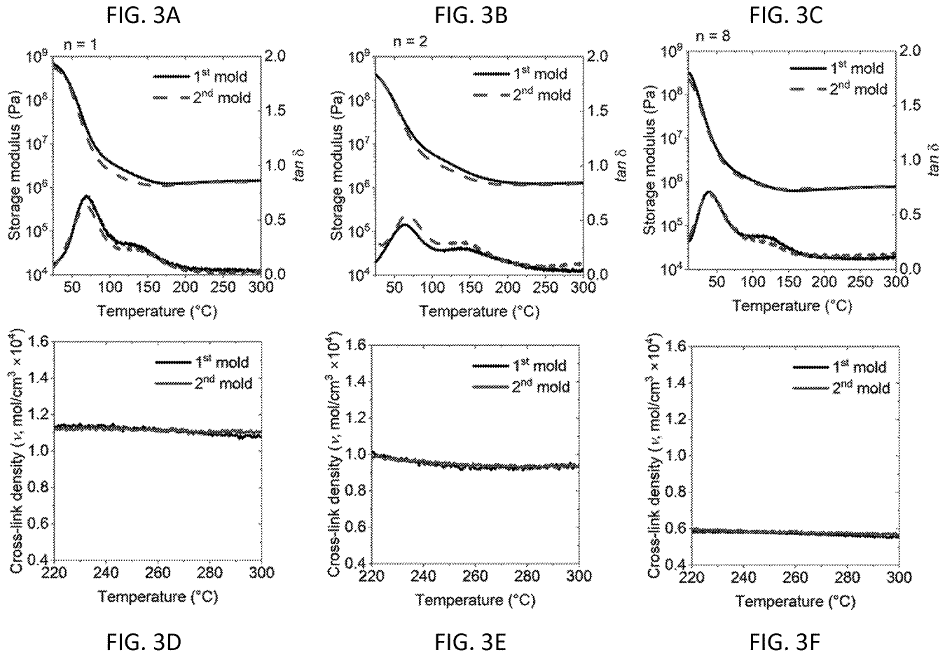

Next, the recovery of properties of the CANs as a function of the reprocessing step were investigated by compression molding at 250° C. (FIGS. 3A-3F). Cross-link density was plotted as a function of temperature (calculated from Equation 1 for each reprocessing step in FIGS. 3D-3F), and it was observed that cross-link density was fully recovered after reprocessing and that cross-link density effectively remained constant with increasing temperature in the rubbery plateau region, even at temperatures where the CANs were reprocessable. These outcomes provided strong indications that the dynamic nature of the internal-amide-catalyzed siloxane exchange was associative or predominantly associative. This type of analysis is relatively rare in the research literature.

Effect of alkyl linker length on stress relaxation of the siloxane-containing CANs. To further understand and quantify the dynamics of the CANs as a function of different alkyl spacer length, tensile stress relaxation experiments were conducted at elevated temperatures where the dynamic chemistry was active. The relaxation curves were fit to the Kohlrausch-Williams-Watts (KWW) stretched exponential model, as shown in Equation 2:

$$\frac{E ( t )}{{E}_{0}} = exp \{ - {( \frac{t}{τ} * )}^{β} \} \qquad ( 2 )$$

where E(t)/E₀ is the normalized stress relaxation modulus at time t, τ* is the characteristic relaxation time, and β(0<β<1) is an exponent reflecting the relaxation distribution breadth, with smaller β associated with a broader relaxation distribution. Equation 3 gives the average relaxation time, <τ>:

$$〈 τ 〉 = \frac{{τ}^{*}}{β} Γ ( \frac{1}{β} ) \qquad ( 3 )$$

where Γ is the gamma function. It was noted that the KWW stretched exponential decay function has generally been found to provide for much better fits of CAN stress relaxation responses than the single exponential Maxwell model. Activation energy (Eₐ) values were obtained from the slope of In <τ> as a function of inverse T (FIGS. 4A-4D), with results tabulated in Table 2.

Notably, the n=1 system, in which the CAN was constructed with the shortest alkyl spacer length and the cross-link density was the highest among the siloxane-containing polyamide CANs (vide supra), exhibited the fastest stress relaxation among all systems tested. To illustrate the dramatic difference in relaxation times, at a common T, e.g., 270° C., the n=1 system had <τ>=35 s, whereas the n=2 and n=8 systems had <τ> values of 371 s and 3480 s, one and two orders of magnitude higher values, respectively.

As an explanation for this behavior, it was posited that it is possible that the amide group facilitated the siloxane hydrolysis reaction to generate a nucleophilic silanol species. Silanols, in the presence of secondary amines, can then undergo exchange with another siloxane group. Siloxane hydrolysis into silanol can be efficiently catalyzed by a neighboring tertiary amine group, a process that exhibited a dependence on the alkyl spacer length. Longer alkyl spacer length between the tertiary amine group and siloxane group led to slower siloxane hydrolysis, due to more entropic penalties for forming a conformation of larger ring structures between the tertiary amine group and siloxane transition states. Furthermore, the rate of dynamic associative chemistry per siloxane group will increase with increasing cross-link density (because the rate of dynamic associative reactions followed a second-order rate law, which scaled with concentration of the siloxane groups times the concentration of silanol groups). Hence, with increasing cross-link density, the modulated distances between exchangeable siloxane linkages (due to the design of siloxane-containing diester monomer) can lead to higher concentrations of exchangeable groups within the CANs. In turn, this facilitated the associative siloxane exchange chemistry, resulting in the dramatic reduction of average relaxation times with decreasing alkyl chain length.

Other interesting points regarding the stress relaxation phenomena concern the breadth of relaxation distribution (denoted by the β parameter) and the activation energy (Eₐ). It was observed that the breadth of relaxation distribution increased (reflected by a decrease in β) with increasing alkyl spacer length (and decreasing cross-link density). One possible reason is the entropic penalties for forming a conformation of larger ring structures between the amide group and siloxane transition states increased with increasing alkyl spacer length. This, in turn, broadened the distribution of chain segments participating in the dynamic chemistry, hence decreasing the β parameter. Additionally, it was observed that Eₐ was independent (within experimental uncertainty) of cross-link density and alkyl spacer length. This indicated that the underlying mechanisms governing the internal-amide-catalyzed siloxane exchange did not change with increasing alkyl spacer length.

To test the rationale for the underpinnings of the stress relaxation on cross-link density, a network with a mixture of n=1 diester monomer and n=8 diester monomer was designed to achieve a concentration of siloxane and amide equal to that of purely n=2 diester monomer system. Given the densities of the siloxane-containing diester monomers, it was found that a mixture of 80 wt % n=1 diester monomer and 20 wt % n=8 diester monomer achieved identical overall siloxane and amide concentrations to those of the pure n=2 monomer (see Table A). Identical synthesis, reprocessing, and stress relaxation testing procedures were followed. Then, the stress relaxation was measured at equivalent temperatures to those of the n=2 system, and a faster stress relaxation was observed for the mixture of n=1 and n=8 system (FIG. 5). For example, at 270° C., the <τ> values for the n=2 system and the mixture of n=1 and n=8 system were 371 and 246 s, respectively, with β values of 0.58 and 0.62, respectively. The inventors acknowledge the likelihood of local heterogeneity present in the mixture n=1 and n=8 system, with regions that are lean in n=1 segments (or conversely, rich in n=1 segments) contributing to the distributions of relaxation times (as shown by the (exponent values being smaller than those of the pure n=1 system). Nevertheless, this exercise indicated that the cross-link density (and thus, concentrations of exchangeable groups) played a substantial role in governing relaxation times in associative CANs, and, thus, is a crucial consideration in designing associative exchange CANs with optimal reprocessability.

TABLE 2
Characteristic relaxation times, stretching exponent
(β), average relaxation times, and Arrhenius activation
energy values from stress relaxation measurements
of the siloxane-containing polyamide networks.

| Sample | T [° C.] | τ* [s] | β | <τ> [s] | R² |
|---|---|---|---|---|---|
| n = 1 | 200 | 771 | 0.70 | 976 | 0.998 |
| | 220 | 331 | 0.71 | 413 | 0.997 |
| | 240 | 117 | 0.69 | 150 | 0.998 |
| | 250 | 74 | 0.74 | 89 | 0.998 |
| | 260 | 45 | 0.73 | 55 | 0.994 |
| | 270 | 29 | 0.75 | 35 | 0.997 |
| | 280 | 20 | 0.70 | 26 | 0.994 |
| n = 2 | 250 | 596 | 0.54 | 1044 | 0.999 |
| | 260 | 334 | 0.56 | 558 | 0.992 |
| | 270 | 232 | 0.58 | 371 | 0.993 |
| | 280 | 140 | 0.61 | 206 | 0.997 |
| | 290 | 90 | 0.63 | 127 | 0.990 |
| n = 8 | 260 | 2658 | 0.48 | 5750 | 0.991 |
| | 270 | 1402 | 0.45 | 3480 | 0.991 |
| | 280 | 874 | 0.43 | 2410 | 0.992 |
| | 290 | 451 | 0.40 | 1500 | 0.991 |
| Mixture of | 250 | 494 | 0.58 | 778 | 0.994 |
| n = 1 and n = 8 | 260 | 295 | 0.70 | 372 | 0.994 |
| | 270 | 186 | 0.67 | 246 | 0.992 |
| | 280 | 106 | 0.62 | 153 | 0.998 |
| | 290 | 69 | 0.65 | 94 | 0.996 |

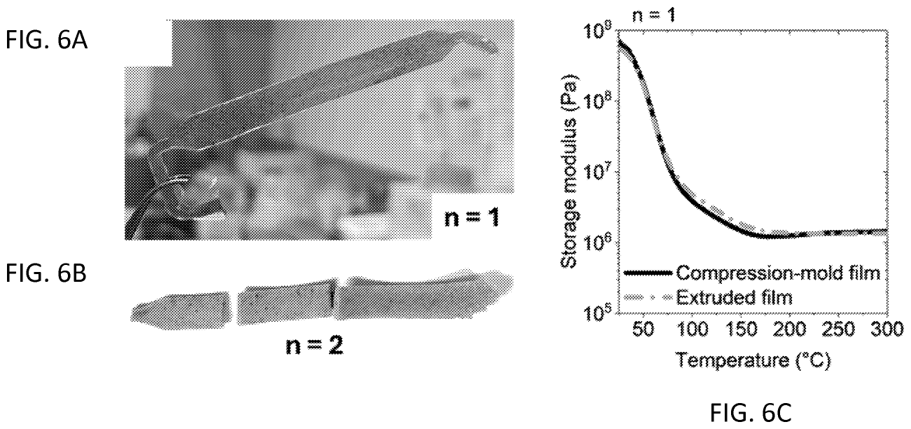

Implications of stress relaxation results for siloxane-containing polyamide CAN reprocessability by melt extrusion. Next, an evaluation for the commercial adoption of CANs was considered. In particular, some commercial applications of CANs may require that CANs be amenable to melt-state extrusion. At present, neither dynamic siloxane networks nor polyamide networks have been reported to be extrudable. Considering the excellent thermal stability of the present CANs and the fast stress relaxation (particularly of the n=1 sample), it was envisioned that the siloxane-containing polyamide CANs would be amenable to facile extrudability (FIGS. 6A-6C).

Melt extrusion of the n=1 and n=2 samples was carried out using a small-scale, twin-screw extruder at a temperature of 260° C. and a rotational screw speed 5 rpm, set at the cycling mode (where the material was continuously redirected into a backflow channel mold, mimicking a pseudo-injection molding process) for 10 min. The system was also continuously flushed with N₂ throughout the feeding and cycling process. Facile extrusion of the n=1 system yielded a robust molded sample that was transparent and had the same color as the compression molded samples. However, attempts to extrude the n=2 system under the same extrusion conditions led to samples that resembled compacted powder in several pieces, not a well-consolidated robust material, indicating unsuccessful extrusions. Dynamic mechanical analysis of the n=1 system extrudate revealed that the temperature-dependent storage modulus values of the extrudate fully recovered those of the 1^{st}-molded n=1 sample obtained by compression molding (FIG. 6C). This includes the rubbery plateau region, indicating that the extruded sample fully recovered the cross-link density of the compression-molded sample.

The present amide-catalyzed siloxane exchange may be applied to other commercially attractive thermoset chemistries, e.g., epoxy, urea-formaldehyde, melamine resins, etc. To this end, the extrusion experiments reflect a crucial lesson regarding network design, concentrations of exchangeable groups, and implications of stress relaxation times for the (re) processability of CANs. With associative CANs, an increase in cross-link density increases the dynamic response because the rate of dynamic exchange is a second-order reaction, scaling with the concentration of each of two reactant species involved in the associative exchange. In turn, this leads to more facile melt extrudability of associative CANs with increasing cross-link density. Because the siloxane-based polyamide CANs demonstrate melt-extrudability with complete cross-link density recovery, they further accentuate the potential for internally amide-catalyzed siloxane exchange to be implemented in developing melt-processable and recyclable polymer networks on a commercial scale.

### CONCLUSIONS

This Example introduced the development of siloxane-exchange-based CANs with internal catalysis. Internal catalysis was demonstrated through small-molecule studies, which showed for the first time that amide groups covalently bonded via alkyl spacers to siloxane groups will catalyze siloxane exchange. By controlling the alkyl spacer length, the concentrations of siloxane groups and amide groups, and thereby cross-link density, were systematically tuned. Each CAN exhibited a rubbery plateau modulus that was proportional to absolute temperature at temperatures (~200-300° C.) where stress relaxation occurred, i.e., where the networks had dynamic character. This means that the cross-link density was temperature-independent and that the CAN dynamics were associative. Full recovery of cross-link density was attained by reprocessing with compression molding, although the reprocessing times and temperatures increased with decreasing cross-link density, i.e., decreasing siloxane concentration. Average stress relaxation times also increased dramatically with decreasing cross-link density. The inverse dependencies of reprocessing and average relaxation times on cross-link density arose because the rate of associative exchange is second order in siloxane concentration. Considering practical adoption of these reprocessable CANs, this Example demonstrated that the highest cross-link density CAN (n=1 system) underwent facile extrusion with a resulting cross-link density equal to that obtained after compression molding. In contrast, the CAN with the next highest cross-link density could not be extruded into a well-consolidated material using identical extrusion conditions, highlighting the important structure-processability relationships in associative CANs.

Additional information, including that described above as being “not shown,” may be found in U.S. provisional patent application No. 63/774,273 that was filed Mar. 19, 2025, the entire contents of which are incorporated herein by reference.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more” refers to use of different types of the relevant entity. Similarly, terms such as “same” and the like, encompass, but do not require an exact correspondence of the referenced parameter/property.

Throughout the present disclosure, terms such as “comprising” and the like may be replaced with terms such as “consisting” and the like.

What is claimed is:

1. A dynamic siloxane-containing polyamide network comprising a polyamide network, portions of which are covalently linked via dynamic siloxane diamide linkages, each dynamic siloxane diamide linkage comprising a siloxane moiety positioned between two amide moieties and separated from each amide moiety by respective linker groups.

2. The network of claim 1, wherein each dynamic siloxane diamide linkage has formula —HNC(O)R″Si(R″)₂OSi(R″)₂R″C(O)NH—, wherein each R″ is independently selected from an alkyl group and an aryl group and each R″ is independently selected from hydrogen and an alkyl group.

3. The network of claim 2, wherein the alkyl group is a linear alkyl group.

4. The network of claim 3, wherein the linear alkyl group has from 2 to 10 carbon atoms.

5. The network of claim 4, wherein the linear alkyl group is unsubstituted.

6. The network of claim 2, wherein the aryl group is an alkyl phenyl group.

7. The network of claim 2, wherein each R″ is an independently selected linear alkyl group.

8. The network of claim 7, wherein the linear alkyl group has from 2 to 10 carbon atoms.

9. The network of claim 8, wherein the linear alkyl group is unsubstituted.

10. The network of claim 1, wherein the network is free of a catalyst other than that provided by the dynamic siloxane diamide linkages.

11. The network of claim 1, wherein each dynamic siloxane diamide linkage has formula —HNC(O)(CH₂)ₙSi(CH₃)₂OSi(CH₃)₂(CH₂)ₘC(O)NH—, wherein each n is independently in a range of from 2 to 10.

12. The network of claim 11, wherein each n is 3.

13. The network of claim 1 comprising a polymerization product of a siloxane diester monomer, a diamine, and a multifunctional ester monomer.

14. The network of claim 13, wherein the siloxane diester monomer has formula R′OC(O)R″Si(R″)₂OSi(R″)₂R″C(O)OR′, wherein each R′ is an independently selected alkyl group; each R″ is independently selected from an alkyl group and an aryl group; and each R″ group is independently selected from hydrogen and an alkyl group;
wherein the diamine has formula H₂NRNH₂, wherein R is selected from an alkyl group, an ether group, and an aryl group; and
wherein the multifunctional ester monomer has formula (R^{V}OC(O))ₙR^{IV}, wherein each R^{V} group is an independently selected alkyl group, R^{IV′} is an alkyl group or an aryl group, and n is greater than 2.

15. The network of claim 14, wherein each R″ is an independently selected unsubstituted linear alkyl group having from 2 to 10 carbon atoms.

16. The network of claim 15, wherein R is a cycloalkyl group.

17. The network of claim 16, wherein each R^{V} is a linear alkyl group, R^{IV} is a cycloalkyl group, and n is 3.

18. A method of reprocessing the network of claim 1, the method comprising heating the network to a reprocessing temperature for a reprocessing time to induce siloxane exchange reactions between dynamic siloxane diamide linkages, the siloxane exchange reactions catalyzed by amide moieties of the dynamic siloxane diamide linkages; reshaping the network; and cooling the network to a temperature at which the siloxane exchange reactions are arrested.

19. A method of forming the network of claim 1, the method comprising inducing polymerization reactions between a siloxane diester monomer, a diamine, and an ester monomer.

20. A precursor composition for forming the network of claim 1, the composition comprising a siloxane diester monomer, a diamine, and an ester monomer.
